(19) United States
(12) Patent Application Publication
(10) Pub. No.: US 2025/0082442 A1
(43) Pub. Date: Mar. 13, 2025

(54) DENTAL IMPLANT

(71) Applicant: Nobel Biocare Services AG, Kloten (CH)

(72) Inventors: Yannick Lovis, Glattpark (CH); Jörg Weitzel, Rielasingen-Worblingen (DE)

(21) Appl. No.: 18/727,360

(22) PCT Filed: Jan. 11, 2023
(86) PCT No.: PCT/EP2023/050577

§ 371 Date: Jul. 9, 2024

(30) Foreign Application Priority Data
Jan. 12, 2022 (EP) 22151174.4

(51) Int. Cl. A61C 8/00

(52) U.S. Cl. CPC A61C 8/0025; A61C 8/0024

(57) ABSTRACT

The present disclosure relates to a dental implant comprising a core body having an apical end, a coronal end, and an outer surface. The core body extends along a longitudinal axis between said apical end and said coronal end. The dental implant further includes a first thread extending from the outer surface of the core body, the first thread being formed at least partially along the core body. The first thread comprises an apical thread end, a coronal thread end, and a front face at the apical thread end. The front face comprises at least one cutting edge.

### TECHNICAL FIELD

The present disclosure relates to a dental implant for insertion into bone tissue.

### PRIOR ART

Dental implants are used as an artificial root for a dental restauration. That is, dental implants provide anchorage for an artificial tooth in the upper or lower jawbone of a patient. It is known that proper anchorage of the dental implant in the bone is crucial for the stability of the implant as well as for osseointegration of the implant and, thus, also for long-term success of the dental restauration.

During implant surgery, a dentist usually prepares a recess in the bone tissue using a drill and subsequently inserts the dental implant into the previously prepared recess. For insertion of the dental implant into bone tissue, dental implants typically comprise a thread formed on the outer surface of the dental implant by means of which the dental implant is screwed into the bone.

Dental implants may further comprise a cutting flute formed at an apical portion of the implant with a cutting edge for cutting into bone tissue. Such a cutting flute intersects multiple turns of the thread, wherein at these intersections the thread forms part of the cutting edge. In the process of insertion of the implant, the rotation of the implant results in the cutting edge cutting bone tissue.

The bone situation differs from patient to patient, i.e. in terms of density, orientation and quality of bone. Consequently, the dentist may be confronted with a relatively high or relatively low bone density depending on the patient receiving treatment. Further, the dental situation likewise influences treatment. For example, the height of the bone can be greatly reduced for partially or totally edentulous patients resulting in a need for short implants, i.e. implants having a relatively short longitudinal length. Particularly for these implants, stable anchoring is crucial for a successful outcome of treatment.

In dense bone situations or when using short implants, dental implants with a standard cutting flute have a tendency to wobble during insertion or, in other words, are difficult to be aligned with and inserted into the prepared bone recess. Furthermore, known implants have shown to deviate from the desired insertion path. Moreover, there is the risk that a dental implant is overtightened during insertion of the dental implant into the bone recess, which means that the insertion torque rapidly decreases and the dental implant shows rotational freedom (around the longitudinal axis) in the final position, what is called a spinning implant. These effects render the installation of these implants more difficult, even in case of a previously prepared bone recess.

### SUMMARY OF THE INVENTION

In view of the above, there remains the need for a dental implant which enhances stability of the implant during and after insertion. Accordingly, the objective of the present invention is to provide a dental implant which particularly addresses above-noted adverse effects observed.

In answer to this objective, the present disclosure provides a dental implant according to the subject matter of the independent claim, wherein the claims dependent thereon define preferred embodiments.

The disclosure provides a dental implant comprising a core body having an apical end, a coronal end, and an outer surface, wherein the core body extends along a longitudinal axis between said apical end and said coronal end. The dental implant also includes at least one thread, also called a first thread, extending from the outer surface of the core body and formed at least partially along the core body. The first thread comprises an apical thread end, a coronal thread end, and a front face at the apical thread end. At the apical thread end, the front face may extend, preferably radially, between the first thread apical flank and the first thread coronal flank. The front face forms or comprises at least one cutting edge.

The core body may substantially have a cylindrically, conically or frustoconically shaped body along the longitudinal axis. It is also possible that the core body comprises different shapes along the longitudinal axis, for example a coronal portion of the core body is cylindrical and an apical portion of the core body has a tapered, conical or frustoconical shape. An outline of the cross-sections of the core body perpendicular to the longitudinal axis may preferably be substantially round and more preferably substantially circular or oval. It is particularly preferred that an outline of the cross-sections of an apical portion of the core body is substantially circular or oval. Nonetheless, the outline of the cross-section of the core body and, in particular of the apical portion of the core body, may include at least one linear section. Therefore, the term substantially is used since the outline may include at least one linear section (resulting from a groove or a flute which are further described in the following) that causes the outline to deviate from a strict round or circular shape.

The core body may comprise cross-sections along the longitudinal axis, the cross-sections being perpendicular to the longitudinal axis, wherein the apical end comprises a substantially round, preferably substantially circular, cross-section.

The substantially round or substantially circular outline of an apical portion, in particular of the apical end, of the core body facilitates a guiding and centering effect of the implant. Expressed differently, since the substantially round or circular outline does substantially not have a projecting edge whatsoever in a direction perpendicular to the longitudinal axis, the apical portion or the apical end of the core body may achieve centering or guiding within the bone recess. Furthermore, the insertion of the implant into the bone recess is enhanced. Additionally, the substantially round or circular outline further avoids an overly compression of the bone.

The apical end of the core body is preferably formed as a rounded tip.

A rounded tip means that the edge connecting the apical end face of the core body and the outer surface of the core body is substantially rounded. In other words, there is preferably no discontinuity between the apical end face and the outer surface of the core body. The apical end of the core body may also be formed substantially spherically.

Thereby, the insertion of the dental implant into the bone recess is even further enhanced.

The first thread of the dental implant extends or protrudes from the outer surface of the core body, i.e. it projects outwardly from the core body in a direction substantially perpendicular to the longitudinal axis (i.e. in a radial direction). Accordingly, the outer surface of the core body forms the root of the first thread.

Further, the first thread is formed at least partially along the core body, which means that the first thread does not need to be present along the full length of the core body. Nonetheless, the first thread may also extend along the entire core body.

The first thread is preferably formed helically around the core body. Moreover, the first thread may be formed with a coronal flank, an outer flank and an apical flank, the outer flank connecting the coronal flank and apical flank. The first thread may, however, also be formed in a way that the coronal flank and the apical flank intersect each other. In this case, the outer flank is substantially not present or at least reduced to a line. It is also possible that the flanks of the first thread may be formed differently along the longitudinal axis. For example, in an apical portion of the first thread, the coronal flank and the apical flank may be more angled with respect to each other and/or a radial outer flank may be smaller than in a coronal portion of the first thread.

The first thread may be formed as a single thread which means that a single thread path is formed from the coronal thread end to the apical thread end. It is further possible that the first thread is formed as a multiple thread, preferably as a double thread. In this case, the multiple thread paths, preferably two thread paths, of the first thread are formed from the coronal thread end to the apical thread end. Accordingly, at the apical thread end, such a multiple threaded first thread comprises multiple front faces, preferably two front faces. The multiple front faces are preferably equally distanced from each other along the circumference of the core body.

The angle of the first thread's front face with respect to the outer surface of the core body may be in a range of 75° to 105°, 80° to 100°, 85° to 95°, or 87° to 93° or may preferably be substantially 90°. The angle is measured in a crosssectional profile between a line formed by the front face and the tangential line of outer surface of the core body at the intersection between the front face line and the outer surface line of the core body.

The at least one cutting edge of the front face is for cutting bone tissue. The cutting edge extends along the peripheral edge of the front face. The front face may comprise (exactly) three cutting edges, for example, a coronal flank, an apical flank and an outer flank of the first thread, the outer flank connecting the coronal flank and apical flank. Alternatively, the front face may comprise (exactly) two or (exactly) one cutting edge. For embodiments with a first thread in the form of a multiple thread, each front face may comprise at least one cutting edge.

According to the present disclosure, the first thread has at the apical thread end a front face. The front face of the first thread at the apical thread end forms a cutting edge that defines a thread height at the front face. In other words, the apical thread end is discontinuous instead of continuously approaching the outer surface of the core body. In particular, the first thread is not formed with a typical thread runout at its apical end, i.e. with a portion where the height of the first thread in relation to the core body of the dental implant is continuously reduced to zero over at least a quarter turn of the thread. The skilled person will appreciate that a reduction of the height of the first thread that results from an angled front face with respect to the core body is not understood as a typical thread runout in the present context.

Thereby, a cutting edge is formed which, upon insertion of the dental implant, immediately cuts with its predefined height into the bone tissue. This facilitates anchoring the dental implant within the bone tissue compared to a thread which is formed with a typical thread runout. More particular, the thread path of the first thread is cut into the bone tissue with the predetermined height, which facilitates that bone tissue is also seated in a satisfying manner in between the turns of the first thread. Additionally, the cutting of the front face with a predetermined height also limits compression of the bone that otherwise be exerted by the first thread.

The front face of the first thread at the apical thread end further reduces the risk of a spinning implant. In other words, it has been surprisingly shown that dental implants with such a front face are less likely to spin in their final position within the bone recess, i.e. an undesired rotational movement around the longitudinal axis in the final position. It is believed that this is facilitated due to a more aggressive cutting edge which cuts with a cutting edge having a relatively large height into the bone tissue and is, thus, better anchored (especially in a rotational direction) within the bone recess.

The front face of the first thread at the apical thread end further causes the following advantageous effect. Dental implants may get misaligned near the final position of insertion due to bone chips or a change in bone density. This causes a deviation of the implant from its predetermined path of insertion due to a shift of the center of rotation and the risk for a misaligned seat of the dental implant within the bone recess. Without wishing to be bound by theory, the cutting action of the front face bites more readily into such bone tissue portions and, thus, prevents misalignment of the implant to an undesired direction.

Especially for embodiments of the dental implant comprising more than one, i.e. multiple, front faces and consequently multiple cutting edges, the risk for a misaligned insertion of the dental implant into the bone recess is reduced which may otherwise result from a single cutting edge projecting outwardly from the core body.

The core body of the dental implant may further comprise a first portion and a second portion, wherein the first portion and second portion extend along the longitudinal axis. The second portion is located apically of the first portion, wherein the first thread extends at least partially along the first portion.

Preferably, the second portion extends from the apical end towards the coronal end.

As previously described with respect to the core body, the first portion and/or the second portion of the core body may comprise a substantially cylindrical and/or tapered shape. Preferably, the first portion and/or the second portion is shaped substantially tapered, conical or frustoconical. The first portion and second portion may comprise a different outer shape. For example, the first portion may be cylindrical whereas the second portion may be tapered. In another example, the first portion and the second portion may both be tapered. The taper angle measured from the longitudinal axis to the outer surface of the second portion may be higher, equal or lower than the taper angle of the first portion.

It is also possible that the first portion and the second portion have a similar or substantially the same, preferably cylindrical or tapered, outer shape.

Preferably, the apical thread end is located within the first portion.

The first thread, in particular the apical thread end of the first thread, is preferably formed at a predefined distance from the apical end of the core body. In case of a second portion being present, the first thread preferably does not extend into the second portion. However, the first thread may be adjacent to a second thread of the second portion, as will be described further below.

This configuration allows an insertion of the dental implant before the thread of the implant gets into contact with bone tissue, in particular bone tissue after the preparation of a bone recess (for example, a so-called pilot hole). Such an apical portion of the dental implant without the first thread may be inserted into the bone recess without rotational movement of the implant.

During insertion of the implant, the apical portion of the dental implant inserted into the bone recess may advantageously achieve guidance and a centering effect by the time when the first thread comes into contact with the bone tissue. Thereby, the insertion of the dental implant is facilitated and, in particular, the risk of a wobbling movement of the dental implant upon insertion is reduced.

Moreover, the first thread not being present in an apical portion of the dental implant has the effect that a predetermined insertion torque is less likely exceeded while the second portion already provides guidance during insertion and a surface for providing stability, in particular for bone ingrowth after implantation (secondary stability).

The centering and guidance effect may further be adapted by the predefined distance from the apical end of the core body at which the first thread, in particular the apical thread end of the first thread, is formed, or by the longitudinal as well as lateral extension of the second portion for example in dental situations where a good guidance and centering of the implant is of primary importance. Further, it is possible to form dental implants of different lengths with, however, a substantially similar first thread design, i.e. such dental implants may only differ in the design of the apical portion of the implant without the first thread.

The dental implant may further comprise a spiral groove extending at least partially along the core body.

The spiral groove is recessed inwardly from the outer surface of the core body and extends in a helical fashion at least partially along the core body. The dental implant may comprise a single or multiple, preferably two or three, spiral grooves.

The spiral groove preferably forms a root of a second thread. In particular, a line connecting points along the spiral groove which are recessed most inwardly from the outer surface of the core body may form the root of the second thread. In case of a spiral groove, the outer surface of the core body preferably forms the outer diameter of the second thread. In other words, the second thread defined by a spiral groove does not extend outwardly from the outer surface of core body of the dental implant in a direction perpendicular to the longitudinal axis but instead is recessed into said outer surface.

Adjacent turns of the spiral groove preferably have the same pitch as the pitch of the first thread.

The second thread is preferably shifted by half a pitch relative to the first thread. Alternatively, the second thread may extend along the projected path of the first thread, i.e. along the theoretical path of the first thread if the first thread continued beyond the apical thread end.

The second thread may be formed as a single thread or multiple threads, preferably two or three threads. This means that there may be one or multiple, preferably two, thread paths for the second thread along the core body, wherein each thread path is formed by a separate spiral groove. The number of second threads is preferably equal to the number of first threads (for example, the first thread being a double thread results in the second thread being a double thread).

According to the present disclosure, the second thread and/or the spiral groove may extend at least partially along the second portion.

The second thread may, thus, be formed apically of the first portion, i.e. of the first thread. However, the second thread may also be formed so as to extend at least partially into the first portion. In contrast, the first thread may not extend beyond the first portion towards the apical end. However, it may extend (with its apical flank) up to the boundary between the first portion and the second portion.

Preferably, the second thread extends along the core body up to the apical end of the core body. However, it is also possible that the core body comprises an apical end where the second thread is not present, i.e. the second thread is present at a distance from the apical end.

The second thread may support insertion of the dental implant by pulling the implant into the bone recess upon contact with bone tissue of a previously prepared bone recess. At the same time, the second thread allows an apical portion of the implant, i.e. the second portion, to be inserted into the bone recess with or without rotation of the implant, still serving as guidance and for centering before the first thread gets into contact with the bone tissue.

Moreover, the second portion with the second thread allows to move and distribute bone chips, which may still be left in the bone recess from the procedure of preparing the bone recess. The distribution of bone chips leads to an improved and accelerated osseointegration caused by the biological vital chips that are collected from the bottom of the osteotomy and distributed coronally the along osteotomy. The axial distribution of bone chips has the advantage to prevent an accumulation of these chips that may otherwise result in areas of increased compression at the apical end of theosteotomy. The radial distribution of bone chips around the implant reduces the risk of spinning of the implant in the final position and the risk that the implant is not correctly seated in the bone tissue. In addition, the combination of the first thread and of the second thread leads to a bi-cortical anchoring of the implant.

A height of the first thread is preferably larger than a height of the second thread.

The height of the first and second thread according to the present disclosure is measured from the root to the radial outer flank of the respective thread in a direction perpendicular to the outer surface of the core body.

The second thread preferably has a smaller thread height than the height of the first thread. This allows a partial insertion of an apical portion of the implant into the bone recess without rotation of the implant for guidance and centering of the implant. The height of the second thread, however, still allows to pull the implant into the bone recess upon rotation of the implant in a softer way than the first thread. This softer way enhances guidance of the implant towards a planned path of insertion.

The first thread is preferably formed helically around the core body with a first pitch and the second thread is formed helically around the core body with a second pitch, wherein the first pitch may be substantially equal to the second pitch. The first and second pitch may also be different, i.e. the first pitch may be greater or lower than the second pitch.

The dental implant and in particular the core body may further comprise a cutting flute, wherein the cutting flute may comprise at least one cutting edge. The at least one cutting edge of the front face of the first thread preferably forms part of the at least one cutting edge of the cutting flute.

A cutting flute in the context of the present disclosure generally refers to a recess or a flattened portion along the dental implant's core body (e. g. longitudinal direction) to form an edge, i.e. a cutting edge, which is configured to cut bone tissue. The cutting flute may be formed substantially along a straight line or may, alternatively, also be formed along a curved or a spiral line.

The cutting flute contributes to facilitating insertion of the dental implant in the bone tissue as well as to achieving the desired insertion torque during insertion of the implant. At the same time, the cutting flute may also limit compression of the bone tissue by cutting the same.

It is preferred that the cutting flute is of a shallow type (i.e. the depth of the recess or the flattened portion of the core body along the circumference thereof is relatively small). This facilitates that the effect of the front face of the first thread is not diminished and the outline of the cross-section of the apical portion, preferably the one of the apical end of the core body remains substantially circular or oval.

Preferably, the cutting flute extends along the first portion and the second portion. Even more preferably, the cutting flute extends from the apical end towards the coronal end and may extend beyond the second portion into the first portion.

Thereby, the dental implant is provided with a cutting capability starting at the second portion, i.e. the portion of the implant which is first in contact with bone tissue during insertion of the implant.

The cutting flute may intersect three, preferably two and most preferably one turn of the first thread.

In other words, three, two or one turn of the thread path of the first thread may be interrupted by the cutting flute. Thereby, the interrupted turns of the thread also form a cutting edge which influence the cutting behavior of the cutting flute. Preferably, the first thread turn starts at the cutting flute. Thus, the first thread turn may only have a forward cutting capability without having a backward cutting capability (i. e. it is not interrupted). In other words, the first thread turn only cuts bone tissue while the implant is screwed into the bone tissue, whereas due to the lack of a cutting line there is no cutting capability when turning the implant into the opposite direction. The latter may, for example, be temporarily done during implantation to reduce torque if the torque exceeds a predetermined value.

Consequently, it is possible that the cutting flute does not interrupt any turn of the first thread but that the apical thread end with the front face of the first thread is located (directly) adjacent to the cutting flute (in other words, the cutting edge of the cutting flute is connected with the cutting edge of the first thread).

Thus, the first thread may have a front face at the apical end of the first thread and be interrupted by the cutting flute. Nonetheless, in case the first thread is not interrupted by the cutting flute but the front face at the apical end of the first thread is located at the cutting flute, at least the apical portion of the first thread is a continuous thread. This corresponds to a case, in which the cutting flute is not affecting the apical portion of the first thread or in which no cutting flute is present. In any of these cases, the first thread has the (one) thread face at its apical end.

The cutting flute may further intersect turns of the second thread and, preferably, all turns of the second thread. The turns of the second thread preferably have a forward cutting capability and/or a backward cutting capability.

Thereby, also the turns of the second thread form a cutting edge which preferably have a differing cutting effect with respect to the interrupted turns of the first thread due to the limited thread height and the shift in pitch. Furthermore, the second thread may comprise a forward and backward cutting capability, which may be advantageous to reduce torque during insertion of the implant.

A cutting capability of the second thread assists in limiting the compression of bone tissue that would, otherwise, be caused by this portion of the implant. This also applies to the cutting capability of the first thread and particularly supports establishing a secondary stability.

The first thread may comprise an outer radius, the front face being formed at a point along the longitudinal axis where the outer radius is minimal or at a minimum.

The outer radius of the first thread refers to the distance between the outer flank of the first thread and the longitudinal axis in a direction perpendicular to the longitudinal axis. The first thread may be formed, but is not limited thereto, with a constant outer radius along the longitudinal axis. The outer radius of the first thread may also be tapered in a direction from the coronal end to the apical end.

The first thread may have an increasing height in a direction from the coronal end to the apical end. In the latter case, the front face is formed by the first thread having its maximum height.

The magnitude of the outer radius and the thread height as well as its/their change along the first thread allow to predefine the compression of bone tissue caused during insertion of the dental implant.

The at least one cutting edge of the front face may comprise a positive or negative rake angle and/or may comprise a positive or negative relief angle.

In a cross-section of the implant perpendicular to the longitudinal axis, the rake angle is the angle at the cutting edge defined between the line representing the front face and the line connecting the longitudinal axis and the cutting edge, i.e. the outermost point of the line representing the flank face. Consequently, if the front face extends outwardly from the outer surface of the core body at an angle to the core body of 90° (i.e. an angle to the tangential line at the point where the front face and the outer surface of the core body intersect), the rake angle would be 0° (neutral rake angle). A positive (or negative) rake angle is formed when the cutting edge is, in a direction of cutting, located or leaning more forward (or backward) than the intersection between the front face and the core body.

The rake angle affects the cutting behavior of the flank face. A positive rake angle generally makes the cutting edge act sharper and more punctual, whereas a negative rake angle makes the cutting edge more blunt (i.e. may result in shifting the effect of the cutting edge towards compressing rather than cutting).

Also in a cross-section of the implant perpendicular to the longitudinal axis and measured at the outermost point of the line representing the front face, the relief angle is defined between the tangential line of the thread's outer flank of the actual thread (thread with a decreasing, constant, or increasing radius) and the tangential line of the thread's outer flank assuming the thread having a constant radius.

Accordingly, a thread having a constant radius has a relief angle of 0° and a thread with a decreasing (increasing) radius in a direction from the coronal to the apical end has a negative (positive) relief angle.

The relief angle also allows to influence the cutting behavior of the flank face. A positive relief angle creates a sharper cutting edge whereas a negative relief angle makes the cutting edge more blunt resulting in the effects already described above.

### BRIEF DESCRIPTION OF THE DRAWINGS

The following figures illustrate embodiments of dental implants according to the present disclosure. These embodiments are not to be construed as limiting the claims but for enhancing the understanding of the invention in context with the following description. In these figures, same reference signs refer to features throughout the drawings that have the same or an equivalent function and/or structure. It is to be noted that a repetitive description of these components is generally avoided for reasons of conciseness. Further:

FIG. 1 is a perspective view of a dental implant according to the present disclosure;

FIG. 2 is a perspective view of an apical portion of the dental implant illustrated in FIG. 1;

FIG. 3 is a side view of the apical portion of the dental implant shown in FIG. 2;

FIG. 4 is a bottom view in an apical-coronal direction illustrating the apical face side of the dental implant of the previous figures; and

FIG. 5 is a perspective view of an apical portion of another embodiment of a dental implant according to the present disclosure.

### DETAILED DESCRIPTION

In the following, exemplary embodiments of a dental implant according to the present disclosure are described in detail with reference to the accompanying figures.

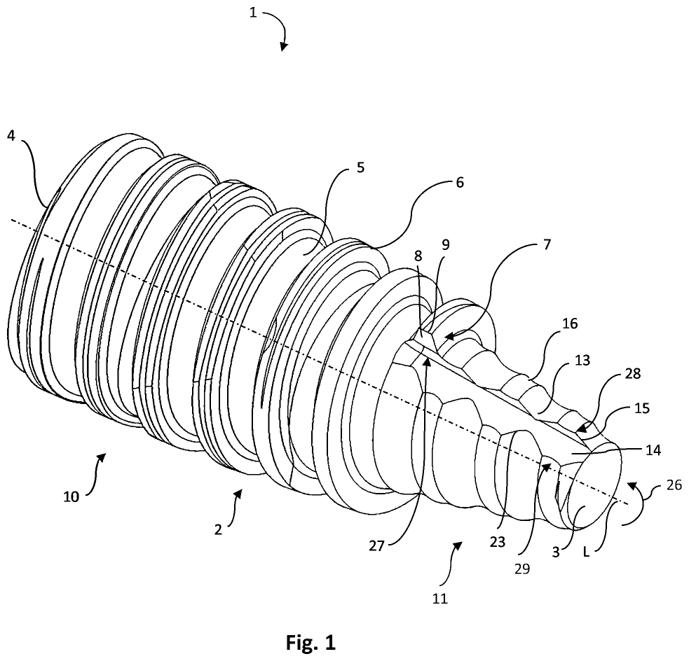

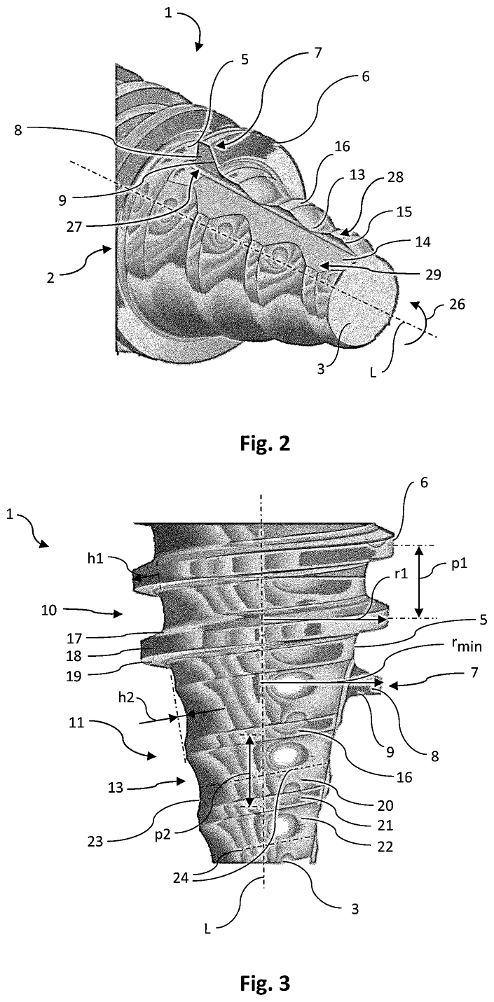

FIGS. 1 and 2 are perspective views of a dental implant 1 according to the present disclosure. The dental implant 1 comprises a core body 2 which has an apical end 3 and a coronal end 4. The core body 2 extends along a longitudinal axis L between the apical end 3 and the coronal end 4. The core body 2 has an outer surface 5 which surrounds the longitudinal axis L. This outer (circumferential) surface 5 generally defines the core body 2. Some of the other features of the dental implant described in the following are defined in relation to this core body 2 (e.g. threads, grooves).

At the coronal end 4, the dental implant 1 may comprise an engagement portion (not shown) which is configured to get into engagement with a further component of a dental replacement (e.g. an abutment, a dental restoration).

The outer shape of the core body 2 along the longitudinal axis L is not limited to a specific shape. As described above, the core body 2 may be a substantially cylindrical or tapered body. In particular, the core body 2 may have a conical or frustoconical shape.

In some embodiments, the core body 2 may also comprise multiple, in particular two, portions along the longitudinal axis. Such a portion of the core body 2 may comprise a substantially cylindrical or tapered, preferably conical or frustoconical, outer shape. Each portion of the core body 2 may comprise a different outer shape or all portions comprise substantially the same or a similar outer shape. For example, a coronal portion of the core body 2 may be shaped substantially cylindrically and an apical portion of the core body 2 may be tapered. However, other combinations of the above-mentioned shapes are also possible. In another example, the core body 2 may be tapered with different taper angles along the longitudinal axis, i.e. a coronal portion of the core body 2 may be have a lower taper angle than an apical portion of the core body 2 (or vice versa). It is also possible that they have the same taper angle.

In a preferred embodiment, the core body 2 may comprise a first portion 10 and a second portion 11 which extend along the longitudinal axis L. Preferably, the second portion 11 is located apically of the first portion 10. In particular, the second portion 11 may extend from the apical end 3 towards the coronal end 4 of the core body 2. The first portion 10 and/or the second portion 11 may comprise a continuous outer shape or a combination of outer shapes as described above.

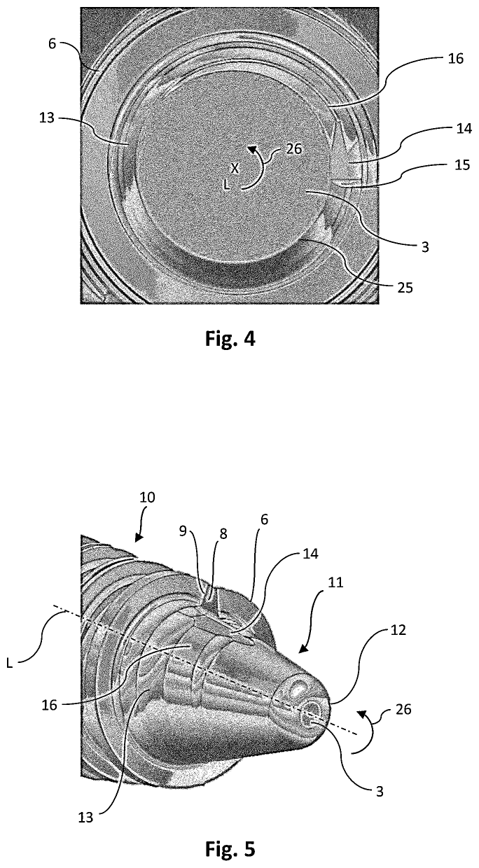

The core body 2 may further comprise cross-sections along the longitudinal axis L. Cross-sections referred to, are generally cross-sections perpendicular to the longitudinal axis L. The outlines 25 of the cross-sections of the core body 2 are not limited to a specific shape. It is preferred that the cross-section of the apical end 3 of the core body 2 comprises a substantially round or substantially circular outline 25 (as shown in FIG. 4).

The term “substantially” is used since there may be further features, e.g. a groove or a flute which are described in more detail below, which cause the outline 25 of the crosssections of the core body 2, in particular in an apical portion of the core body 2, to deviate from a strict round or circular outline 25 (e.g. including at least one linear section).

The outline of the cross-section of the apical end 3 of the core body 2 which is formed substantially round or substantially circular facilitates insertion of the dental implant 1 into the bone recess. Moreover, the substantially round or circular outline of the apical end 3 allows for easy centering of the implant during insertion.

As best visible in FIG. 5, the apical end 3 of the dental implant 1 may also be formed as a rounded tip 12. This means that the edge or edges between the face of the core body 2 at the apical end 3 and the outer surface 5 of the dental implant 1 are substantially rounded and/or chamfered. It is also possible that the apical end 3 is formed spherically. In any case, the skilled person will appreciate that a thread 6, 16 extending to such a substantially rounded and/or chamfered edge will follow this geometry in this region.

The roundness and/or chamfer enhances insertion of the dental implant 1 since these edges of the dental implant 1 at the apical end 3 are inserted first into the bone tissue or a previously prepared bone recess, such as a so-called pilot hole.

The dental implant 1 further comprises a first thread 6 which extends or protrudes from the outer surface 5 of the core body 2. In other words, the first thread 6 is formed as an external thread on the outer surface 5 of the core body 2, wherein the outer surface 5 forms the root of said first thread 6.

The first thread 6 comprises an apical thread end 7 and a coronal thread end (not shown in the figures) and is formed at least partially along the core body 2. The apical thread end 7 and the coronal thread end may or may not fall together with the apical end 3 and/or the coronal end 4, respectively. Moreover, the first thread 6 is formed helically around the core body 2 with a first pitch p1 (see FIG. 3).

As particularly shown in FIG. 1, in the apical portion of the implant, the first thread 6 is preferably formed as a continuous thread with the apical thread end 7. Nonetheless, the first thread 6 may also be formed as a thread interrupted by a cutting flute 14 as will be described further below. Such a first thread 6 is a discontinuous thread with a front face 8 at the apical end 7, a coronal end, and interruptions between its apical end 7 and the coronal end.

As is visible from FIG. 3, the first thread 6 may be formed with a coronal flank 17, an outer radial flank 18 and an apical flank 19. The outer radial flank 18 may be linear and/or rounded. A linear outer flank has a constant or variable width and/or may at least partially be defined by forming an edge (i.e. forming an edge that connects the apical flank 19 and the coronal flank 17).

The first thread 6 comprises a height h1 which is measured between the root of the first thread 6, i.e. the outer surface 5 of the core body 2, and the outer radial flank 18 in a direction perpendicular to the outer surface 5. The height h1 of the first thread 6 may or may not be constant along the extension of the first thread 6. If not being constant, the height of the first thread preferably increases in a direction from the coronal end 4 to the apical end of the dental implant 1.

The first thread 6 also comprises an outer radius r1. The outer radius r1 is measured between the longitudinal axis L and the outer radial flank 18 in a direction perpendicular to the longitudinal axis L. The outer radius r1 of the first thread 6 may or may not be constant along the extension of the first thread 6. If not being constant, the outer radius preferably decreases in a direction from the coronal end 4 to the apical end of the dental implant 1, i.e. the dental implant tapers in this direction along the first thread 6.

Due to the first thread 6, the dental implant 1 is pulled into the prepared bone recess upon rotation of the dental implant 1 in a predetermined direction of rotation 26. The predetermined direction of rotation 26 is the direction into which the dental implant 1 is rotated for advancing the dental implant 1 into the bone recess. Once inserted, the first thread 6 also provides anchorage for the dental implant 1 in the bone recess.

At the apical thread end 7, the first thread 6 comprises a front face 8. In other words, the first thread 6 ends at the apical thread end 7 with a certain thread height h1, preferably the maximum thread height h1 of the first thread 6. The front face 8 is formed at a predetermined angle with respect to the outer surface 5 of the core body 2. In a preferred embodiment, the angle of the front face 8 with respect to the outer surface 5 is substantially 90°. However, the front face 8 may also be formed with an angle of substantially 80°, 85°, 95° or 100° with respect to the outer surface 5 or with an angle within one of the angular ranges specified above.

The front face 8 comprises at least one cutting edge 9. The cutting edge 9 may be configured to cut bone tissue. In particular, the front face 8 may comprise exactly one, two or three cutting edges. For example, an edge portion/entire edge of the coronal flank 17 and/or an edge portion/entire edge of the outer radial flank 18 and/or an edge portion/entire edge of the apical flank 19 at the periphery of the front face 8 may form the cutting edge 9 along the front face 8.

It is possible that the connecting edges between the three flanks 17, 18, 19 are substantially rounded and/or chamfered at the front face 8. If the transition between the three flanks 17, 18, 19 is rounded so that the transition from the edge of the flank 17 to the edge of the flank 18 to the edge of the flank 19 forms a continuous edge of the front face 8, a single cutting edge 9 is formed. Nonetheless, the cutting edge may be formed by juxtaposed cutting edges, wherein the transition between these cutting edges is discontinuous (e.g. in case of a chamfer or a transition between the flanks at a vertex).

Having the front face 8 at the apical thread end 7, the first thread 6 does not comprise a continuous thread runout at the apical thread end 7. A typical thread runout is understood as an end portion of the thread where the height of the thread is reduced from a certain height to zero over at least a quarter or even one-eighth of a turn. Thus, the person skilled in the art will appreciate that the discontinuous reduction of the height h1 of the first thread 6 resulting from the angled front face 8 with respect to the outer surface 5 of the core body 2 does not form a thread runout.

As shown in the figures, the front face 8 of the first thread 6 readily forms a cutting edge 9 with a predefined height since the first thread 6 is not formed with a typical thread runout. Thus, upon insertion and rotation of the dental implant 1 in the bone recess, the front face 8 immediately cuts with a certain height, preferably the maximum height of the first thread 6, into the bone tissue. It has been observed that this arrangement advantageously results in a cutting behavior, with a reduced risk of spinning when the dental implant is fully inserted. By preventing spinning of the implant, i.e. turning the dental implant 1 without an advancement of the implant into the bone tissue in accordance with the pitch of the first thread 6, the anchorage of the dental implant 1 is enhanced.

Moreover, the front face 8 also significantly influences the insertion torque of the dental implant 1, which fosters initial stability of the dental implant 1 as well as osseointegration. As a result, dental implants 1 having a length to diameter ratio of less than two are still provided with sufficient anchoring for a reliable attachment to the surrounding bone tissue.

Further, the cutting action of the front face 8 at the apical thread end 7 of the first thread 6 cuts the bone tissue in a optimized way. This improves anchorage of the dental implant 1 within the bone tissue of a patient.

The front face 8 is preferably formed at a point along the longitudinal axis where the outer radius r1 of the first thread 6 is at a minimum (rₘᵢₙ). Additionally or alternatively, the front face 8 preferably comprise a height h1 of the first thread 6 which is at a maximum.

Thereby, it is possible to advantageously modify the cutting behavior of the front face 8, i.e. to what extent the front face 8 cuts into the bone tissue, for enhancing anchorage of the dental implant 1, in particular for dental implants that are relatively short (e.g. length to diameter ratio of about two and below).

The front face 8 of the first thread 6 is configured as a forward cutting tooth 27 upon rotation of the dental implant 1 in the predetermined direction of rotation 26. Further, the dental implant 1 and/or the first thread 6 does not comprise a backward cutting edge, i.e. a thread face facing the front face 8. In other words, the dental implant 1 and/or the first thread 6 does not comprise a backward cutting edge along the projected path of the first thread 6 beyond the apical thread end 7. This means that the front face 8 is not formed by such an interruption of the first thread 6 so that the first thread 6 is separated into two adjacent parts resulting in establishing another thread face that acts as a backward cutting edge.

A forward cutting edge is defined in the present context as the edge which is configured to cut bone tissue when the dental implant 1 is rotated along the predetermined direction of rotation 26 and is, however, configured to not cut bone tissue when the dental implant 1 is rotated in the direction opposite to the predetermined direction of rotation 26.

In FIGS. 1 and 2, the first thread 6 is illustrated as a single thread. In other words, the first thread 6 only comprises a single thread path from the coronal thread end to the apical thread end 7. In an alternative embodiment, the first thread 6 may also be formed as multiple threads, in particular as a double thread. This means that multiple thread paths, in particular two thread paths, are formed between the coronal thread end and the apical thread end 7. In other words, the first thread is formed along multiple parallel thread paths.

In such embodiments, the first thread 6 comprises multiple, preferably two, front faces 8, wherein each front face 8 comprises at least one cutting edge 9. The multiple front faces 8 are preferably equally distributed along the circumference of the core body 2.

A first thread 6 comprising multiple threads results in a more balanced cutting behavior and, thus, reduces the risk that the dental implant 1 may unintentionally tilt upon insertion.

Preferably, the first thread 6 extends at least partially along the first portion 10. The apical thread end 7 of the first thread 6 may be located within the first portion 10. In other words, the first thread 6 may end within and preferably at the apical end of the first portion 10. Thus, the term “within” also encompasses in the present context the ends of the first portion 10 along the longitudinal axis.

In particular, the first thread 6 does not extend beyond the first portion 10 in an apical direction of the dental implant 1. Further, the first thread 6 is preferably not formed up to the apical end 3 of the core body 2. In other words, the dental implant 1 preferably comprises an apical portion, preferably the second portion 11, where the first thread 6 is not present.

This configuration allows the apical end 3 of the dental implant 1 to be inserted into the bone recess without the first thread 6 yet getting into contact with bone tissue. Further, such an apical portion of the dental implant 1 may be inserted into the bone recess without rotation of the dental implant 1. This has the advantageous effect that, when the first thread 6 gets into contact with the surrounding bone tissue, the apical portion of the dental implant 1, which is inserted into the bone recess, already provides guidance and centering during a rotational movement of the dental implant. This reduces the risk for misalignment of the dental implant 1 with respect to the bone recess.

Additionally, the apical portion of the dental implant 1 may be formed differently as a second portion 11 (e.g. different shape, taper angle) for enhancing the guiding and centering effect of the dental implant 1.

Due to the guiding and centering effect of the apical portion of the dental implant 1 when already inserted into the bone recess, the risk of a “wobbling” movement of the dental implant 1 can be significantly reduced.

As illustrated in FIGS. 1 and 2, the dental implant 1 may further comprise a spiral groove 13 which extends at least partially along the core body 2. The spiral groove 13 is preferably recessed inwardly in relation to the outer surface 5 of the core body 2. The cross-sectional outline or profile 23 of the spiral groove 13 perpendicular to its direction of extension is not limited to a specific shape but is preferably round, in particular substantially circular or substantially elliptical. The spiral groove 13 is formed along a helical path running around the core body 2. In the exemplary embodiment illustrated in the figures, there is (exactly) one spiral groove 13 formed in the core body 2. It is, however, also possible that the core body 2 comprises more than one, preferably two, spiral grooves 13.

The spiral groove 13 preferably forms a root 24 of a second thread 16. More particularly, the root 24 of the second thread 16 is formed by a line in the spiral groove 13 along points which are most recessed from the outer surface 5. Since the spiral groove 13 is recessed from the outer surface 5 of the core body 2 and preferably extends helically around the core body 2, it may form a second thread 16. For example, a portion of one turn of the spiral groove 13 forms a coronal flank 20 of the second thread 16 and a portion of an adjacent turn of the spiral groove 13 forms the adjacent apical flank 22 of the second thread 16.

The outer radial flank 21 of the second thread 16 is preferably formed by the outer surface 5 of the core body 2. This means that the second thread 16 may not extend outwardly from the outer surface 5 of the core body 2 in a direction perpendicular to the longitudinal axis L.

The second thread 16 is formed like the spiral groove 13 with a height h2, wherein the height h2 is measured between the root 24 of the second thread 16 and the outer radial flank 21 in a direction perpendicular to the longitudinal axis L. The height h2 of the second thread 16 may or may not be constant along the extension of the second thread 16. As already described in relation to the spiral groove 13, the height h1 of the first thread 6 is preferably larger than the height h2 of the second thread 16.

Further and according to the arrangement of the spiral groove 13, the second thread 16 is extending helically around the core body 2 with a second pitch p2. The second pitch p2 may be substantially the same as the first pitch p1 of the first thread 6. Preferably, the second thread 16 is shifted by half a pitch relative to the first thread 6 (as shown in FIGS. 1 and 2). As a result, the root 24 of the second thread 16 is on the same helical line as the apex of the first thread 6.

Nonetheless, the second thread 16 may also not be shifted with respect to the first thread 6. In the latter case, the second thread 16 is formed along the projected path (i.e. helical line) of the first thread 6. In other words, the second thread 16 may or may not extend along the same path as the first thread 6.

The second thread 16 and the spiral groove 13 extend at least partially along the second portion 11. Moreover, the second thread 16 and/or the spiral groove 13 are preferably only formed apically of the first thread 6. It should be noted that the second thread 16 and/or the spiral groove 13 may extend beyond the second portion 11 in a coronal direction. Accordingly, the second thread 16 and/or the spiral groove 13 may also be present in the first portion 10 and may or may not overlap at least partially with the first thread 6. Preferably, the second thread 16 and/or the spiral groove 13 at least extend coronally to be adjacent to the first thread 6. In this respect, the transition from the first thread 6 to the second thread 16 and/or spiral groove 13 is preferably abrupt, i.e. without any continuous transformation but discontinuous.

The second thread 16 achieves the advantageous effect to pull the dental implant 1, upon rotation of the dental implant 1, at least partially into the prepared bone recess. At the same time, due to the limited thread height of the second thread 16, the dental implant 1 allows for at least partial insertion into the bone recess without rotation. As described above, this achieves a centering and/or a guiding and/or a bi-cortical anchorage effect when the first thread 6 gets into contact with the surrounding bone tissue.

For this effect, it is advantageous if the second thread 16 and/or spiral groove 13 is formed with at least one-eighth, one-fourth, one-third, one-half, one, two, or three turns. The more turn, the more pronounced is the advantageous effect of the second thread 16 and/or spiral groove 13. Nonetheless, second thread 16 and/or spiral groove 13 may also extend less than one-eighth turn around the second portion 11.

It is also advantageous if the second thread 16 and/or spiral groove 13 substantially extends to the apical end of the dental implant 1. Substantially in this context means that the most apical tip of the dental implant 1 may be rounded so that the second thread 16 and/or spiral groove 13 does not exactly end at the apical end 3 of the dental implant 1.

The second thread 16 further allows to remove or advantageously arrange bone chips in a previously prepared bone recess that may, for example, be left in the recess from the process of preparing the bone recess. During insertion of the dental implant 1, this prevents bone chips from causing a misalignment of the dental implant 1 as well as spinning of the implant in the final position.

In another embodiment of the dental implant 1 according to the present disclosure and best visible in FIG. 2, the dental implant 1 may comprise a cutting flute 14. The cutting flute 14 may be a recessed portion from the outer surface 5 or flattened portion on the outer surface 5 along the core body 2, in particular extending at least partially along the first portion 10 and the second portion 11. The cutting flute 14 preferably has a longitudinal direction in an apical-coronal direction of the dental implant 1. The cutting flute 14 comprises at least one cutting edge 15 configured to cut bone tissue. Preferably, the at least one cutting edge of the front face 8 forms part of the cutting edge 15 of the cutting flute 14 and is even more preferably continuous with the cutting edge of the flute 14.

The cutting flute 14 allows for a predefined limitation of compression of bone tissue and, thus, may be adapted to foster osseointegration of the dental implant 1.

Preferably, the cutting flute 14 is formed in such a way that the outline of the cross-section of the apical end 3 of the core body 2 remains substantially round (except for a linear or curved interruption due to the cutting flute 14). Thereby, it is ensured that the effect of the front face 8 of the first thread 6 is not diminished and that the apical portion of the dental implant 1 still achieves the guiding and centering effect.

In a preferred embodiment, the cutting flute 14 extends from the apical end 3 towards the coronal end 4. In particular, the cutting flute 14 may intersect three, two or one turn of the first thread 6. The edges between the flanks 17, 18, 19 of the intersected turns and the front face 8 of the first thread 6 preferably forms part of the cutting edge 15. Accordingly, the front face 8 may form part of the cutting flute 14.

The cutting flute 14 may further intersect at least one turn of the second thread 16 and, preferably, all turns of the second thread 16. Similar to the first thread 6, the edges between the flanks 20, 21, 22 and the front face 28 of the second thread 16 also preferably form part of the cutting edge 15. Thus, the front face 28 of each turn of the second thread 16 may also be the result of forming the cutting flute 14.

As best visible from FIG. 2, the second thread 16 may form a forward cutting edge 15 as well as a backward cutting edge 29 according to the predetermined direction of rotation 26 of the dental implant 1 in the process of insertion of the dental implant 1 in the bone recess. The forward cutting edge 15 and the backward cutting edge 29 may form part of the cutting edge 15 of the cutting flute 14. However, the backward cutting edge 29 preferably has a negative rake angle resulting in the backward cutting edge being dull in comparison to the forward cutting edge 15.

During rotation of the dental implant 1 in the process of insertion of the dental implant 1 (predetermined direction of rotation 26), the forward cutting edge 15 is configured to cut bone tissue. During rotation of the dental implant 1 counter to the predetermined direction of rotation 26, e.g. if the torque applied to the dental implant 1 exceeds a predetermined value, the backward cutting edge 29 serves to clear the helical path of insertion from bone material that may have caused the increased torque by cutting and/or tracing (compressing) the thread cut into the bone tissue.

The cutting edge 15 of the cutting flute 14 and/or the cutting edge 9 of the front face 8 may comprise a positive or negative rake angle and/or a positive or negative relief angle.

### REFERENCE SIGNS

1 dental implant
2 core body
3 apical end
4 coronal end
5 outer surface
6 first thread
7 apical thread end
8 front face
9 cutting edge
10 first portion
11 second portion
12 rounded tip
13 spiral groove
14 cutting flute
15 cutting edge
16 second thread
17 first thread's coronal flank
18 first thread's outer radial flank
19 first thread's apical flank
20 second thread's coronal flank
21 second thread's outer radial flank
22 second thread's apical flank
23 outline
24 root of second thread
25 outline
26 predetermined direction of rotation
27 forward cutting tooth
28 forward cutting tooth/front face
29 backward cutting edge

1. A dental implant (1), comprising:
a core body (2) having
an apical end (3),
a coronal end (4), and
an outer surface (5),
the core body (2) extending along a longitudinal axis (L) between said apical end (3) and said coronal end (4);
a first thread (6) extending from the outer surface (5) of the core body (2) and formed at least partially along the core body (2),
wherein the first thread (6) comprises an apical thread end (7), a coronal thread end, and a front face (8) at the apical thread end (7), and
wherein the front face (8) comprises at least one cutting edge (9).

2. A dental implant (1) according to claim 1, wherein
the core body (2) comprises a first portion (10) and a second portion (11), the first portion (10) and second portion (11) extending along the longitudinal axis (L), the second portion (11) being located apically of the first portion (10),
wherein the first thread (6) extends at least partially along the first portion (10).

3. A dental implant (1) according to claim 2,
wherein the apical thread end (7) is located within the first portion (10).

4. A dental implant (1) according to claim 2,
wherein the second portion (11) extends from the apical end (3) towards the coronal end (4).

5. A dental implant (1) according to claim 2,
wherein the second portion (11) comprises a substantially tapered, conical, or frustoconical outer shape.

6. A dental implant (1) according to claim 1,
wherein the dental implant (1) further comprises a spiral groove (13) extending at least partially along the core body (2).

7. A dental implant (1) according to claim 6,
wherein the spiral groove (13) forms a root of a second thread (16), the second thread (16) preferably being shifted by half a pitch relative to the first thread (6).

8. A dental implant (1) according to claim 7,
wherein the second thread (16) and/or the spiral groove (13) extend at least partially along the second portion (11).

9. A dental implant (1) according to claim 7,
wherein a height (h1) of the first thread (6) is larger than a height (h2) of the second thread (16).

10. A dental implant (1) according to claim 7,
wherein the first thread (6) is formed helically around the core body (2) with a first pitch (p1) and the second thread (16) is formed helically around the core body (2) with a second pitch (p2),
wherein the first pitch (p1) is substantially equal to the second pitch (p2).

11. A dental implant (1) according to claim 1,
wherein the dental implant (1) further comprises a cutting flute (14), the cutting flute (14) comprising at least one cutting edge (15),
wherein the at least one cutting edge (9) of the front face (8) forms part of the at least one cutting edge (15) of the cutting flute (14).

12. A dental implant (1) according to claim 11,
wherein the cutting flute (14) extends along the first portion (10) and the second portion (11).

13. A dental implant (1) according to claim 11,
wherein the cutting flute (14) extends from the apical end (3) towards the coronal end (4).

14. A dental implant (1) according to claim 11,
wherein the cutting flute (14) intersects three, preferably two and most preferably one turn of the first thread (6).

15. A dental implant (1) according to claim 1,
wherein the first thread (6) comprises an outer radius (r1), the front face (8) being formed at a point along the longitudinal axis where the outer radius (r1) is minimal (rmin).

16. A dental implant (1) according to claim 1,
wherein the at least one cutting edge (9) of the front face (8) comprises a positive or negative rake angle and/or comprises a positive or negative relief angle.

17. A dental implant (1) according to claim 1,
wherein the core body (2) comprises cross-sections along the longitudinal axis (L), the cross-sections being perpendicular to the longitudinal axis (L),
wherein the apical end (3) comprises a substantially round, preferably substantially circular, cross-section.

18. A dental implant (1) according to claim 1,
wherein the apical end (3) is formed as a rounded tip (12).

19. A dental implant (1) according to claim 1,
wherein the core body (2) comprises a first portion (10) and a second portion (11), the first portion (10) and second portion (11) extending along the longitudinal axis (L), the second portion (11) being located apically of the first portion (10),
wherein the first thread (6) extends at least partially along the first portion (10),
wherein the dental implant (1) further comprises a spiral groove (13) extending at least partially along the core body (2),
wherein the dental implant (1) further comprises a cutting flute (14), the cutting flute (14) comprising at least one cutting edge (15), and
wherein the at least one cutting edge (9) of the front face (8) forms part of the at least one cutting edge (15) of the cutting flute (14).

20. A dental implant (1) according to claim 1,
wherein the core body (2) comprises a second thread (16),
wherein the second thread extends at least partially along the second portion (11),
wherein the first thread (6) is formed helically around the core body (2) with a first pitch (p1) and the second thread (16) is formed helically around the core body (2) with a second pitch (p2), and
wherein the first pitch (p1) is substantially equal to the second pitch (p2).
